(19) United States
(12) Patent Application Publication
(10) Pub. No.: US 2022/0034806 A1
(43) Pub. Date: Feb. 3, 2022

(54) FLUID HANDLING DEVICE, FLUID HANDLING SYSTEM AND LIQUID DETECTION METHOD

(71) Applicant: Enplas Corporation, Saitama (JP)

(72) Inventor: Nobuya SUNAGA, Saitama (JP)

(21) Appl. No.: 17/385,994

(22) Filed: Jul. 27, 2021

(30) Foreign Application Priority Data
Jul. 28, 2020 (JP) 2020-127425
Jan. 19, 2021 (JP) 2021-006529

(51) Int. Cl. G01N 21/51; G01N 21/03; G01N 21/05

(52) U.S. Cl. CPC G01N 21/51; G01N 21/0303; G01N 2021/4702; G01N 2021/058; G01N 21/05

(57) ABSTRACT

A fluid handling device includes a channel including a roughened surface that causes irregular reflection of light. A fluid handling system includes the fluid handling device, an irradiation part for irradiating the roughened surface of the channel with light, and a light detection part for detecting light reflected by the roughened surface or light transmitted through the roughened surface after irradiation from the light irradiation part.

### CROSS REFERENCE TO RELATED APPLICATIONS

This application is entitled to and claims the benefit of Japanese Patent Application No. 2020-127425, filed on Jul. 28, 2020, and No. 2021-006529, filed on Jan. 19, 2021, the disclosure of which including the specification, drawings and abstract is incorporated herein by reference in its entirety.

### Technical Field

The present invention relates to a fluid handling device, a fluid handling system and a liquid detection method.

### Background Art

In recent years, fluid handling systems have been used to analyze trace amounts of substances such as proteins and nucleic acids with high accuracy and speed. Fluid handling systems have the advantage of requiring only a small amount of reagents and samples for analysis, and are expected to be used in a variety of applications such as clinical, food, and environmental testing.

In such fluid handling devices, it is sometimes required to detect the liquid in the channel For example, PTL 1 discloses a technique for detecting the position of the liquid level by a camera placed near the micro fluid chip, and driving a micro pump based on the detection result to displace the liquid level position of the liquid in the channel.

### CITATION LIST

### Patent Literature

PTL 1

Japanese Patent Application Laid-Open No. 2006-275975

### SUMMARY OF INVENTION

### Technical Problem

However, there is a concern that a method of detecting liquids using a camera, as disclosed in PTL 1, will complicate the entire system. In view of the above-mentioned circumstances, an object of the present invention is to provide a fluid handling device that can more easily detect liquid in a channel, a fluid handling system including the fluid handling device, and a liquid detection method using the fluid handling device.

### Solution to Problem

A fluid handling device of an embodiment of the present invention includes: a channel including a roughened surface configured to cause irregular reflection of light.

A fluid handling system of an embodiment of the present invention includes: the above-described fluid handling device; a light irradiation part configured to irradiate the roughened surface of the channel with light; and a light detection part configured to detect light reflected by the roughened surface or light transmitted through the roughened surface after irradiation from the light irradiation part.

A liquid detection method of an embodiment of the present invention includes: introducing liquid into the channel of the above-described fluid handling device; and irradiating the roughened surface of the channel with light, and detecting whether the liquid has reached a region of the channel irradiated with light by detecting light transmitted through the roughened surface or light reflected by the roughened surface.

### Advantageous Effects of Invention

According to the present invention, it is possible to provide a fluid handling device, a fluid handling system, and a liquid detection method that can more easily detect liquid in a channel.

### BRIEF DESCRIPTION OF DRAWINGS

FIG. 1A is a sectional view illustrating a configuration of a fluid handling system according to the embodiment of the present invention;

FIG. 1B is a bottom view illustrating a configuration of a fluid handling device according to an embodiment of the present invention;

FIG. 2A is a schematic cross-sectional view illustrating a state where irregular reflection occurs in a channel including a roughened surface with no liquid;

FIG. 2B is a schematic cross-sectional view illustrating a state where irregular reflection is suppressed in the channel including the roughened surface with liquid;

FIG. 3A is a partially enlarged plan view of a fluid handling device that does not include a light blocking part;

FIG. 3B is a partially enlarged plan view of a fluid handling device including the light blocking part in a portion other than the channel;

FIG. 3C is a partially enlarged plan view of a fluid handling device including a light blocking part also in the channel;

FIG. 4 is a graph illustrating a state where liquid in the channel is detected using the fluid handling device according to the embodiment of the present invention;

FIG. 5A is a graph illustrating results of light measurement using the fluid handling device illustrated in FIG. 3A with or without liquid in the channel;

FIG. 5B is a graph illustrating results of light measurement using the fluid handling device illustrated in FIG. 3B with or without liquid in the channel;

FIG. 6A is a sectional view illustrating a configuration of a fluid handling system according to Embodiment 2 of the present invention; and

FIG. 6B is a bottom view illustrating a configuration of a fluid handling device according to Embodiment 2 of the present invention.

### DESCRIPTION OF EMBODIMENTS

Embodiments of the present invention are elaborated below with reference to the accompanying drawings.

### Embodiment 1

### Configuration of Fluid Handling System

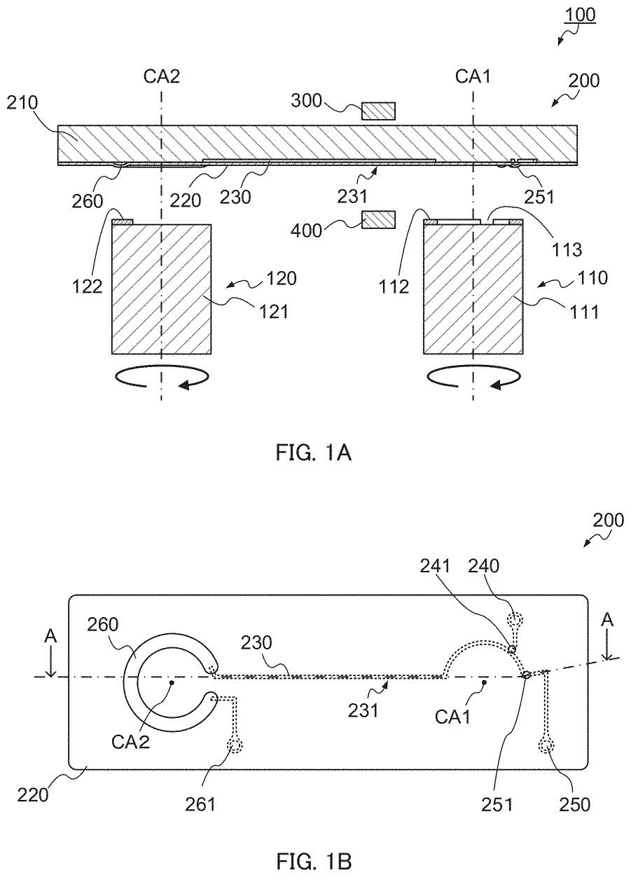

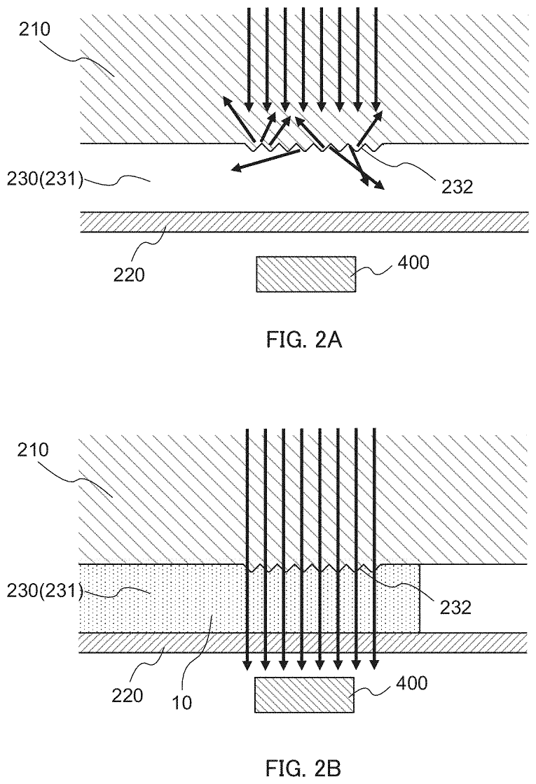

Fluid handling system 100 according to Embodiment 1 is described below with reference to FIGS. 1A to 2B.

FIG. 1A is a sectional view illustrating a configuration of fluid handling system 100 according to the present embodiment. FIG. 1B is a bottom view of fluid handling device 200 according to the present embodiment. In FIG. 1B, inner channel 230 and the like are illustrated with broken lines. The cross-section of fluid handling device 200 in FIG. 1A is a sectional view taken along line A-A of FIG. 1B.

As illustrated in FIG. 1A, fluid handling system 100 according to the present embodiment includes fluid handling device 200, first rotary member 110, second rotary member 120, light irradiation part 300, and light detection part 400. Note that in FIG. 1A, fluid handling device 200, first rotary member 110 and second rotary member 120 are separated for illustration.

As illustrated in FIGS. 1A and 1B, fluid handling device 200 includes channel 230, liquid inlet 240, liquid inlet valve 241, liquid outlet 250, liquid outlet valve 251, rotary membrane pump 260, and ventilation hole 261. In addition, as illustrated in FIGS. 1A and 1B, channel 230 includes detection target region 231 that is irradiated with light for detection of transmitted light or reflection light. As illustrated in FIGS. 2A and 2B, detection target region 231 of channel 230 includes roughened surface 232 configured to cause irregular reflection of light when irradiated with light. In the present embodiment, for the purpose of detecting the position of the liquid in channel 230, light irradiation part 300 irradiate detection target region 231 (roughened surface 232) with light, and light detection part 400 detects transmitted light or reflection light of detection target region 231 (roughened surface 232).

Note that the configuration of fluid handling device 200 is not limited as long as channel 230 includes roughened surface 232 in detection target region 231. The components other than channel 230, detection target region 231 and roughened surface 232 are optional components. In the present embodiment, fluid handling device 200 is composed of substrate 210 in which a groove and a through hole are formed, and film 220 joined to substrate 210 on the surface in which the groove is formed.

In addition, the configuration for carrying liquid in channel 230 of fluid handling device 200 is also not limited. In the present embodiment, by driving rotary membrane pump 260, liquid is introduced into channel 230 from liquid inlet 240, and the liquid in channel 230 is removed from liquid outlet 250.

The liquid introduced from liquid inlet 240 flows through channel 230. In the present embodiment, as illustrated in FIG. 1A, channel 230 is composed of a groove formed in substrate 210 and film 220 that closes the opening of the groove.

As described above, channel 230 includes detection target region 231 including roughened surface 232. Roughened surface 232 is configured to cause irregular reflection of light. In this manner, light detection part 400 can detect the liquid in channel 230 in conjunction with light irradiation part 300.

To be more specific, as illustrated in FIG. 2A, when detection target region 231 is irradiated with light in the state where there is no liquid 10 in detection target region 231 of channel 230, irregular reflection of light occurs at roughened surface 232. On the other hand, as illustrated in FIG. 2B, in the case where there is liquid 10 in detection target region 231 of channel 230, the irregular reflection at roughened surface 232 is suppressed, and thus a larger quantity of light reaches light detection part 400 when detection target region 231 is irradiated with light. In this manner, in the case where roughened surface 232 is formed in detection target region 231, the quantity of reflection light and transmitted light in detection target region 231 significantly changes depending on whether liquid 10 is present in detection target region 231. In this manner, the presence of liquid 10 in detection target region 231 of channel 230 can be detected.

The configuration of roughened surface 232 is not limited as long as irregular reflection is caused when it is not in contact with liquid 10 whereas irregular reflection is suppressed when it is in contact with liquid 10. For example, from a view point of causing irregular reflection, surface roughness Ra (arithmetic average roughness) of roughened surface 232 is preferably 0.001 mm or greater, more preferably 0.05 mm or greater, still more preferably 0.1 mm or greater. It suffices that the upper limit of surface roughness Ra of roughened surface 232 is, but not limited to, 1 mm or smaller. Surface roughness Ra of roughened surface 232 is adjusted by adjusting the surface roughness of the metal mold for forming the groove that constitutes channel 230 in substrate 210, for example.

In addition, preferably, roughened surface 232 is formed in a surface through which a light from light irradiation part 300 is transmitted in the surface that constitutes detection target region 231 of channel 230, more preferably, it is formed in a surface perpendicular to light from light irradiation part 300. In this manner, it is easy to detect the presence of liquid 10 in detection target region 231. The position of detection target region 231 is not limited, and it suffices that detection target region 231 is disposed at a position where the presence of liquid is desired to be detected in channel 230. Note that while roughened surface 232 is the surface constituted by substrate 210 in the surface that constitutes detection target region 231 of channel 230 as illustrated in FIGS. 2A and 2B in the present embodiment, the roughened surface may be the surface constituted by film 220.

The size (the length of channel 230 in the flow direction and the length of channel 230 in the width direction or depth direction) of roughened surface 232 is not limited as long as light detection part 400 can detect the liquid in channel 230 in conjunction with light irradiation part 300. In the present embodiment, the length of channel 230 of roughened surface 232 in the width direction is the same as the width of channel 230.

The width and depth of channel 230 are not limited. In the present embodiment, the width and depth of channel 230 are approximately 20 to 400 μm.

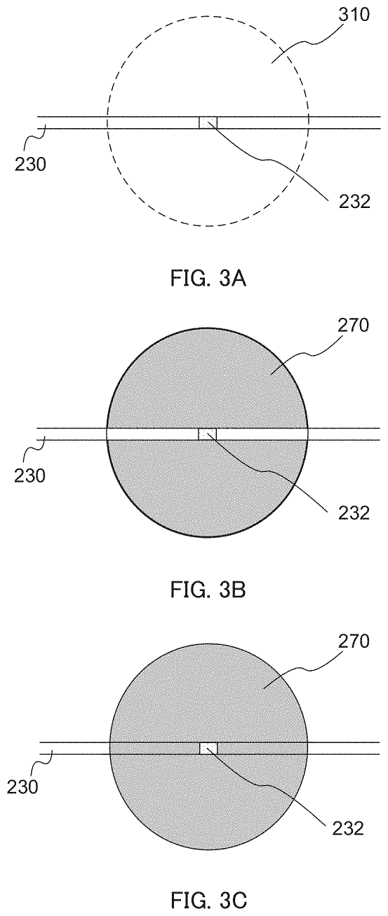

In the case where the width of channel 230 is small, detection target region 231 including roughened surface 232 is also small. Conversely, in some situation the region irradiated with light by light irradiation part 300 (e.g., a light-emitting diode (LED)) and the region where light is detected by light detection part 400 (e.g., a phototransistor) are significantly large with respect to detection target region 231 including roughened surface 232 as indicated with the broken line in FIG. 3A. In the case where the region irradiated with light by light irradiation part 300 and the region where light is detected by light detection part 400 are significantly large with respect to detection target region 231 (roughened surface 232), light detection part 400 may not appropriately detect a change in scattering at detection target region 231 (roughened surface 232). In view of this, fluid handling device 200 may further include light blocking part 270 around detection target region 231. For example, as illustrated in FIG. 3B, in plan view of fluid handling device 200, light blocking part 270 may be disposed without overlapping channel 230. In this manner, light detection part 400 easily detects a change in scattering at detection target region 231 (roughened surface 232) with high sensitivity.

In addition, as illustrated in FIG. 3C, in plan view of fluid handling device 200, light blocking part 270 may be disposed at a position that overlaps a region other than detection target region 231 (roughened surface 232) of channel 230, in addition to the region not overlapping channel 230. In this manner, light detection part 400 easily detects a change in scattering at detection target region 231 (roughened surface 232) with high sensitivity.

The configuration of light blocking part 270 is not limited as long as transmission of light can be blocked. Light blocking part 270 may be, for example, a light-shielding tape bonded on substrate 210 or film 220, a coating film formed in substrate 210 or film 220, or a retroreflective minute prism structure formed in substrate 210.

Liquid inlet 240 is a bottomed recess for introducing liquid into channel 230, and is connected to channel 230. Liquid outlet 250 is a bottomed recess for removing the liquid in channel 230, and is connected to channel 230. In the present embodiment, each of these recesses is composed of a through hole formed in substrate 210, and film 220 that closes one opening of the through hole.

Liquid inlet valve 241 is a membrane valve (diaphragm valve) that controls liquid flow between liquid inlet 240 and channel 230. Liquid outlet valve 251 is a membrane valve (diaphragm valve) that controls liquid flow between channel 230 and liquid outlet 250. In the present embodiment, these valves are rotary membrane valves whose opening and closing are controlled through rotation of first rotary member 110. In the present embodiment, each of these valves is disposed on a circumference of a circle around central axis CA1.

Rotary membrane pump 260 is a space with a substantially arc-like shape (C-shape) in plan view between substrate 210 and film 220. One end portion of rotary membrane pump 260 is connected to channel 230, and the other end portion thereof is connected to ventilation hole 261. Rotary membrane pump 260 functions as a pump for introducing liquid into channel 230 from liquid inlet 240, and pushing out the liquid in channel 230 to liquid outlet 250. In the present embodiment, rotary membrane pump 260 is composed of the bottom surface of substrate 210 and a diaphragm that faces the bottom surface with a space therebetween. The diaphragm is a part of film 220 having flexibility (see FIG. 1A). The diaphragm is disposed on a circumference of a circle around central axis CA2.

First rotary member 110 includes columnar first body 111, first protrusion 112 disposed at the top surface of first body 111, and first recess 113 disposed at the top surface of first body 111. First body 111 is rotatable around first central axis CA1 First body 111 is rotated by an external driving mechanism not illustrated in the drawing. First protrusion 112 for closing liquid inlet valve 241 and liquid outlet valve 251 by pressing the diaphragm of liquid inlet valve 241 and the diaphragm of liquid outlet valve 251, and first recess 113 for opening these valves without pressing the diaphragms are provided at an upper part of first body 111. First protrusion 112 and first recess 113 are disposed on a circumference of a circle around central axis CA1.

Second rotary member 120 includes columnar second body 121 and second protrusion 122 disposed at the top surface of second body 121. Second body 121 is rotatable around second central axis CA2. Second body 121 is rotated by an external driving mechanism not illustrated in the drawing. Second protrusion 122 for operating rotary membrane pump 260 by pressing the diaphragm of rotary membrane pump 260 while making slide contact therewith is provided at the upper part of second body 121. Second protrusion 122 is disposed on a circumference of a circle around central axis CA2.

Light irradiation part 300 irradiates detection target region 231 (roughened surface 232) of channel 230 with light. Light detection part 400 detects whether liquid has reached detection target region 231 by detecting light reflected by roughened surface 232 or light transmitted through roughened surface 232 after the irradiation from light irradiation part 300. As long as the light emitted by light irradiation part 300 can be detected by light detection part 400, the wavelength of the light emitted by light irradiation part 300 is not limited, and is appropriately set in accordance with the type of liquid to be introduced to channel 230, the material of substrate 210 and film 220 and/or the like. For example, light irradiation part 300 is an infrared light emitting diode, and light detection part 400 is a phototransistor. The positions of light irradiation part 300 and light detection part 400 are not limited as long as whether liquid has reached detection target region 231 can be detected. In the present embodiment, regarding the positions of light irradiation part 300 and light detection part 400, light irradiation part 300 and light detection part 400 are disposed opposite to each other with channel 230 therebetween.

### Liquid Detection Method

A liquid detection method according to the present embodiment includes a step of introducing liquid into channel 230 of fluid handling device 200, and a step of irradiating roughened surface 232 of channel 230 with light and detecting whether liquid has reached the region of channel 230 irradiated with light by detecting light transmitted through roughened surface 232 or light reflected by roughened surface 232.

First, liquid introduced in liquid inlet 240 is introduced into channel 230. First, only liquid inlet valve 241 is opened by rotating first rotary member 110, and second rotary member 120 is rotated, and then, the fluid (e.g., air) in channel 230 is suctioned using rotary membrane pump 260. In this manner, the liquid in liquid inlet 240 is introduced into channel 230.

In addition, at this time, whether the liquid has reached the region of channel 230 irradiated with light is detected by irradiating detection target region 231 (roughened surface 232) of channel 230 with light, and detecting light transmitted through roughened surface 232 or light reflected by roughened surface 232. Then, until the liquid reaches detection target region 231, the liquid is introduced into channel 230. To be more specific, light irradiation part 300 irradiates detection target region 231 (roughened surface 232) set in channel 230 with light, and light detection part 400 detects light from detection target region 231 (roughened surface 232), and thus the position of beginning of the liquid introduced to channel 230 is detected. When the liquid has reached detection target region 231, suctioning of rotary membrane pump 260 is stopped by stopping the rotation of second rotary member 120.

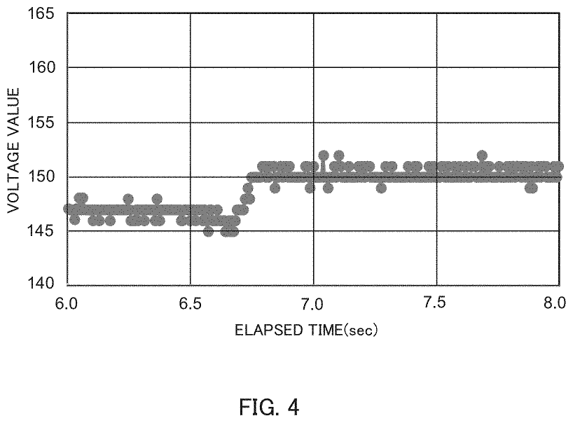

FIG. 4 is a graph illustrating an exemplary detection result at light detection part 400. The abscissa indicates the elapsed time (second), and the ordinate indicates the voltage value (analog 10bit) corresponding to the quantity of detected light.

As described above, when light irradiation part 300 irradiates roughened surface 232 with light in the state where roughened surface 232 is not in contact with liquid, irregular reflection of light occurs as illustrated in FIG. 2A. In this state, the light emitted from light irradiation part 300 does not easily reach light detection part 400. Accordingly, as illustrated around 6.0 to 6.6 seconds in the graph of FIG. 4, the voltage value measured by light detection part 400 is small until the liquid reaches detection target region 231 (roughened surface 232).

Next, when liquid flows in, and light irradiation part 300 irradiates roughened surface 232 with light in the state where roughened surface 232 is in contact with the liquid, the light is easily transmitted as illustrated in FIG. 2B. In this state, the light emitted from light irradiation part 300 easily reaches light detection part 400. Accordingly, as illustrated around 6.7 to 8.0 seconds in the graph of FIG. 4, the voltage measured by light detection part 400 is high after the liquid has reached detection target region 231 (roughened surface 232). As a result, light detection part 400 can detect that the liquid has reached detection target region 231 (roughened surface 232).

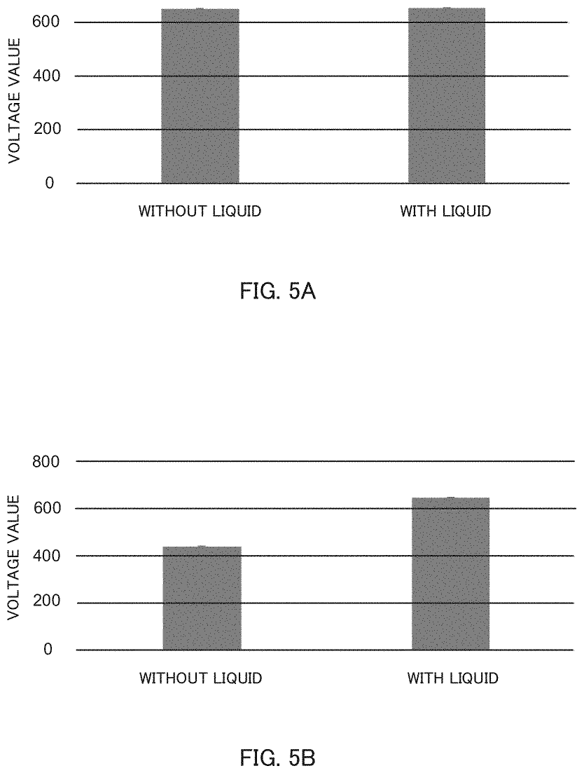

As described above, in the case where the region irradiated with light by light irradiation part 300 and the region where light is detected by light detection part 400 are significantly large with respect to detection target region 231 (roughened surface 232), it is preferable that fluid handling device 200 is provided with light blocking part 270 around detection target region 231. FIG. 5A is a graph illustrating results of light measurement using fluid handling device 200 that does not include light blocking part 270 illustrated in FIG. 3A with or without liquid in detection target region 231. FIG. 5B is a graph illustrating results of light measurement using fluid handling device 200 including light blocking part 270 illustrated in FIG. 3B with or without liquid in detection target region 231. In these graphs, the left side indicates measurement results (voltage values) obtained without liquid in detection target region 231, and the right side indicates measurement results (voltages) obtained with liquid in detection target region 231. It is clear from these measurement results that the arrival of the liquid at detection target region 231 can be more easily detected when light blocking part 270 is provided.

Next, only liquid outlet valve 251 is opened by rotating first rotary member 110, and second rotary member 120 is rotated, and then, the fluid in channel 230 is pushed out using rotary membrane pump 260. In this manner, a predetermined amount of liquid present between liquid inlet valve 241 and channel 230 in detection target region 231 is moved to liquid outlet 250.

Through the above-mentioned procedure, a predetermined amount of liquid can be measured using fluid handling device 200.

### Effect

In the above-described manner, the fluid handling system according to the present embodiment can readily detect the presence of liquid in channel 230.

### Embodiment 2

### Configuration of Fluid Handling System

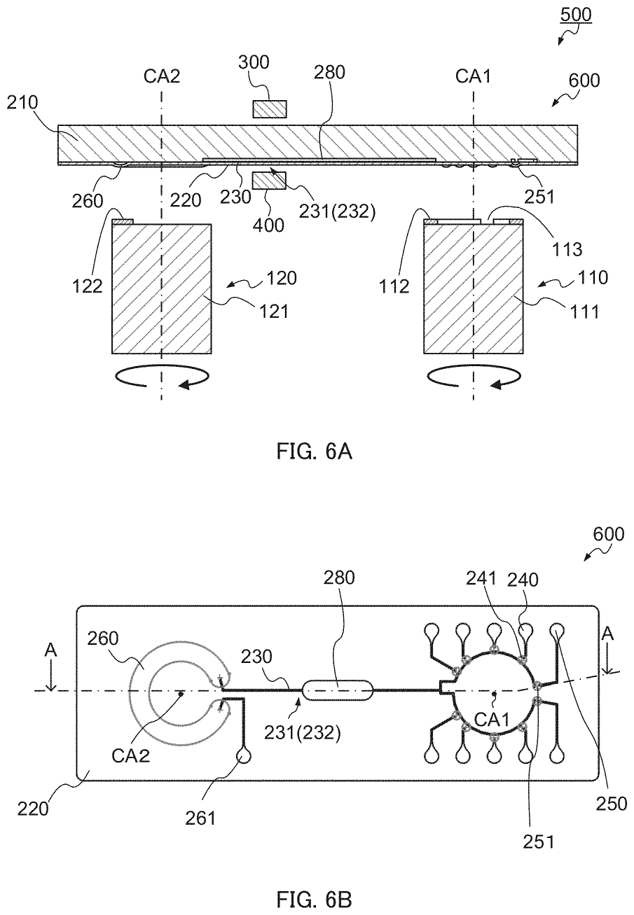

Fluid handling system 500 according to Embodiment 2 of the present invention is described below with reference to FIGS. 6A and 6B. Fluid handling system 500 according to Embodiment 2 is mainly different from fluid handling system 100 according to Embodiment 1 in that liquid storage part 280 disposed in channel 230 is provided, and that the fact that liquid storage part 280 has been filled with liquid can be confirmed. In Embodiment 2, the same components as those of Embodiment 1 are denoted with the same reference numerals and the description thereof will be omitted.

FIG. 6A is a sectional view illustrating a configuration of fluid handling system 500 according to the present embodiment. FIG. 6B is a bottom view of fluid handling device 600 according to the present embodiment. Note that in FIG. 6B, channel 230 and the like, which cannot be directly seen because of film 220, are illustrated for description. The cross-section of fluid handling device 600 in FIG. 6A is a sectional view taken along line A-A of FIG. 6B.

As illustrated in FIGS. 6A and 6B, fluid handling device 600 of fluid handling system 500 includes liquid storage part 280 disposed in channel 230. Liquid introduced from liquid inlet 240 is stored in liquid storage part 280. The configuration of liquid storage part 280 is not limited as long as liquid can be stored. In the present embodiment, liquid storage part 280 is a portion wider than channel 230 as illustrated in FIG. 6B.

In the present embodiment, as illustrated in FIGS. 6A and 6B, detection target region 231 (roughened surface 232) is disposed next to liquid storage part 280. To be more specific, detection target region 231 (roughened surface 232) is disposed next to the end portion of liquid storage part 280 on the downstream side (rotary membrane pump 260 side). With this configuration, it is possible to detect that liquid storage part 280 is completely filled with liquid. In this manner, liquid can be measured, and loss of reagent can be suppressed.

In addition, in the present embodiment, still another detection target region 231 (roughened surface 232) may be disposed next to the end portion of liquid storage part 280 on the upstream side (rotary membrane valve side). With this configuration, it is possible to detect that liquid inside liquid storage part 280 has been completely discharged when the liquid retained in liquid storage part 280 is moved to the rotary membrane valve side.

### Effect

As described above, with the fluid handling system according to the present embodiment, liquid can be stored in liquid storage part 280 without excess or deficiency. In addition, it is possible to confirm that liquid has been completely discharged from liquid storage part 280.

### INDUSTRIAL APPLICABILITY

The fluid handling device, the fluid handling system and the liquid detection method of the present invention are useful in a variety of applications, such as clinical testing, food testing, and environmental testing, for example.

### REFERENCE SIGNS LIST

10 Liquid
100, 500 Fluid handling system
110 First rotary member
111 First body
112 First protrusion
113 First recess
120 Second rotary member
122 Second protrusion
200, 600 Fluid handling device
210 Substrate
220 Film
230 Channel
231 Detection target region
232 Roughened surface
240 Liquid inlet
241 Liquid inlet valve
250 Liquid outlet
251 Liquid outlet valve
260 Rotary membrane pump
261 Ventilation hole
270 Light blocking part
280 Liquid storage part
300 Light irradiation part
400 Light detection part

What is claimed is:

1. A fluid handling device comprising:
a channel including a roughened surface configured to cause irregular reflection of light.

2. The fluid handling device according to claim 1, wherein the roughened surface has a surface roughness Ra of 0.001 mm to 1 mm

3. The fluid handling device according to claim 1,
wherein the channel includes a detection target region configured to be irradiated with light for detection of transmitted light or reflection light, the detection target region including the roughened surface; and
wherein the fluid handling device further includes a light blocking part disposed around the detection target region.

4. The fluid handling device according to claim 3, wherein in plan view of the fluid handling device, the light blocking part is disposed at a position that does not overlap the channel

5. The fluid handling device according to claim 4, wherein in plan view of the fluid handling device, the light blocking part is disposed also at a position that overlaps a region other than the detection target region of the channel

6. The fluid handling device according to claim 1, further comprising:
a liquid storage part disposed in the channel; and
a detection target region disposed adjacent to the liquid storage part at the channel and configured to be irradiated with light for detection of transmitted light or reflection light, the detection target region including the roughened surface.

7. A fluid handling system comprising:
the fluid handling device according to claim 1;
a light irradiation part configured to irradiate the roughened surface of the channel with light; and
a light detection part configured to detect light reflected by the roughened surface or light transmitted through the roughened surface after irradiation from the light irradiation part.

8. A liquid detection method comprising:
introducing liquid into the channel of the fluid handling device according to claim 1; and
irradiating the roughened surface of the channel with light, and detecting whether the liquid has reached a region of the channel irradiated with light by detecting light transmitted through the roughened surface or light reflected by the roughened surface.
